(19) United States
(12) Patent Application Publication
(10) Pub. No.: US 2018/0266701 A1
(43) Pub. Date: Sep. 20, 2018

(54) SOLAR WATER HEATING SYSTEM

(71) Applicants: YOSSI SOFER, HOD HASHARON (IL); EFY EFRAIM OR, ZICHRON YAAKOV (IL)

(72) Inventors: YOSSI SOFER, HOD HASHARON (IL); EFY EFRAIM OR, ZICHRON YAAKOV (IL)

(21) Appl. No.: 15/654,989

(22) Filed: Jul. 20, 2017

Related U.S. Application Data
(63) Continuation-in-part of application No. 15/460,661, filed on Mar. 16, 2017, now abandoned.

(51) Int. Cl. F24D 17/00; F24D 19/10; F24H 9/20; H05B 1/02

(52) U.S. Cl. CPC F24D 17/0063; F24D 17/0015; F24D 11/003; F24H 9/2021; H05B 1/0244; F24D 19/1057

(57) ABSTRACT

A dual heating unit water heating system and method including both an AC heating unit and a DC heating unit installed in a common water heating tank. The system may enable solar power to be integrated into a standard storage heating unit without the need for additional access piping. The AC heating unit includes an AC heating element, and an AC thermostat operable to deactivate the AC heating element when water contained within the water tank exceeds a first threshold temperature. The DC heating unit includes a DC heating element, and a DC thermostat operable to deactivate the DC heating element when water contained within the water tank exceeds a second threshold temperature. The DC power source may be solar panel having an array of photovoltaic cells.

### CROSS-REFERENCE TO RELATED APPLICATIONS

This application is a continuation-in-part of U.S. patent application Ser. No. 15/460,661, filed Mar. 16, 2017.

### FIELD

The embodiments disclosed herein relate to solar heating systems. In particular the embodiments presented relate to storage heaters operable to heat water using either direct current electricity or alternating current electricity.

### BACKGROUND

Storage heaters are used to provide hot water by heating a reservoir of water stored in a tank. Various fuels and heating methods may be used to heat the tank of water such as natural gas, propane, fuel oil, electricity or solar power.

Electric water heaters heat the reservoir of water using electrical resistance elements typically connected to an alternative current (AC) mains electricity supply such as a 220 volt 50 hertz alternative current electrical supply or a 110 volt 60 hertz. In order to control heating, a thermostat is provided which is operable to disconnect the electrical elements when water in the tank exceeds a threshold temperature.

Some electrical water heaters provide an upper heating element for use during periods of heavy water usage and a lower heating element for use as a recovery heater. It is noted that both these heating elements are AC electrical elements and are both connected to the mains electricity.

Electrical water heaters may be combined with secondary heating methods. For example, a propane boiler may be provided with a back up electrical element for use when needed. Similarly in addition to electrical elements, solar powered water heaters may have a solar collector connected to the reservoir via piping such that water is drawn from the reservoir to the solar collector where it is heated and returned to the reservoir. Accordingly, solar thermal heated water tanks require a minimum of four access pipes: an inlet pipe for cold water into the tank, an outlet pipe for hot water from the tank, an outlet feeder pipe from the tank to the solar collector and an inlet return pipe from the solar connector to the tank.

In other solar powered water heaters the solar collector may not be directly connected to the reservoir but rather a separate closed loop may pump a heat transfer fluid or coolant through the solar collector and back into to a heat exchanger immersed within the reservoir. Although in closed loop systems the potable water does not pass through the solar connector the minimum of four access pipes are still required.

It will be appreciated that where such directly heated solar powered water heaters are integrated with electrical heaters, these are solar thermal systems. It will be appreciated that although solar thermal systems are a useful way to reduce fuel usage they require intricate fluid piping systems which are both difficult to install and significantly limit the sites in which the tanks and the solar collectors may be located. There is currently no way to integrate solar heating systems into a storage tank with fewer than four access pipes. Furthermore, solar thermal systems are prone to become damaged through a number of common faults such as freezing, leaks, corrosion, limescale, blockages (in particular within the solar collectors), metal contamination of the water (in particular copper contamination).

Solar energy may also be used to provide electricity typically using photovoltaic (PV) cells arrayed in panels. Photovoltaic cells produce direct current electricity which is not suitable for use with an AC electrical element. As a result, standard electrical storage heaters are not readily integrated with PV electrical sources. Instead a DC-AC power converter may be used to convert a DC input from the DC supply from the PV panels into an AC output for use powering the AC electrical heating unit. Such a system is described in United States Patent Application Number US 2016/0033169 to Refusol Gmbh, which describes a heating device, having a supply electronics unit for operating the heating resistor in a clocked manner to produce an AC power. In such systems although the electrical power supply is drawn from a DC source, the electrical element used to heat the water is not an DC heating element rather it is an AC heating element drawing an AC current from a switching unit. Such switching units are themselves energetically inefficient, costly and may limit the lifetime of the heating system.

It will be appreciated that there is therefore a need for a convenient system for providing solar powered heating which may be integrated with an AC mains powered storage heater. The present disclosure addresses this need.

### SUMMARY

It is one aspect of the current disclosure to introduce a dual heating unit water heating system including both an AC heating unit and a DC heating unit installed in a common water heating tank. The AC heating unit includes an AC heating element, an AC thermostat operable to deactivate the AC heating element when water contained within the water tank exceeds a first threshold temperature, a live input terminal configured to connect to a live mains transmission line; and a neutral input terminal configured to connect to a neutral mains transmission line.

The DC heating unit includes a DC heating element, a DC thermostat operable to deactivate the DC heating element when water contained within the water tank exceeds a second threshold temperature; a positive input terminal configured to connect to a positive DC power transmission line; and a negative input terminal connected to a negative DC power transmission line. Where required, the first threshold temperature equals the second threshold temperature.

It is noted that the DC power source of the dual heating unit water heating system of may be solar panel having an array of photovoltaic cells.

Where required, the DC heating element may be configured to be immersed into the tank at an element-height h_{DC} and the tank is configured to contain water up to a fill-height H wherein the element-height h_{DC} is less than or equal to two-thirds of the fill-height H. Similarly, the AC heating element may be configured to be immersed into the tank at an element-height h_{AC} and the tank is configured to contain water up to a fill-height H wherein the element-height h_{AC} is less than or equal to two-thirds of the fill-height H.

According to various embodiments, the AC heating element is connected to the AC connector via the AC thermostat and the AC thermostat is operable to deactivate the AC heating element when water contained within the tank exceeds a threshold temperature. Similarly, the DC heating element is connected to the DC connector via the DC thermostat and the DC thermostat is operable to deactivate the DC heating element when water contained within the tank exceeds a threshold temperature.

Optionally, the DC heating element comprises an outer sheath, a heating coil, a first cold pin connecting the heating coil to a positive DC connector and a second cold pin connecting the heating coil to a negative DC connector, and an insulating filler disposed between the outer-sheath and the heating coil and wherein the heating coil is selected to have a resistance of between 5 to 15 ohms when a voltage of 120 volts is applied between the positive DC connector and the negative DC connector.

As appropriate, the DC thermostat comprises DC switches having arc protection components such as arc suppressing capacitors.

It is another aspect of the current disclosure to introduce a solar water heating system comprising the water heating system and further comprising a solar panel comprising an array of photovoltaic cells, a positive output terminal and a negative output terminal. The positive DC power transmission line may be connected to the positive output terminal; and the negative DC power transmission line may be connected to the negative output terminal.

It is still another aspect of the current disclosure to introduce a water heating system comprising a tank, and a retrofittable heating unit, the retrofittable heating unit. The unit may include an AC connector for connecting to a mains power source; a DC connector for connecting to a DC power source; an AC heating element; a DC heating element; a DC thermostat; and a terminal block configured to fasten to a wall of the tank and to provide access therethrough for the AC heating element, the DC heating element and the DC thermostat. The terminal block comprises a first dock for supporting the AC heating element; a second dock for supporting the DC heating element; and a third dock for supporting the DC thermostat.

Variously, the terminal block may comprise a screw-in flange connector ring having an external thread configured to engage an internal thread through the wall of the tank. The connector ring may encompass a central channel and the first dock, the second dock and the third dock provide access through the central channel. Additionally or alternatively, the terminal block may comprise a flanged connector configured to be bolted to the wall.

It is yet another aspect of the current disclosure to teach a method for providing a solar heating system, the method comprising: providing a storage heating tank; providing an AC heating unit comprising an AC heating element, an AC thermostat operable to deactivate the AC heating element when water contained within the storage heating tank exceeds a first threshold temperature, a live input terminal and a neutral input terminal; providing a DC heating unit comprising a DC heating element, a DC thermostat operable to deactivate the DC heating element when water contained within the storage heating tank exceeds a second threshold temperature; a positive input terminal and a negative input terminal; connecting the live input terminal and the neutral input terminal to a mains power transmission line; connecting the positive input terminal to a positive DC transmission line; and connecting the negative input terminal to a negative DC transmission line.

Optionally, the method further comprises providing a DC power source.

Where appropriate, the method further includes: providing a solar panel comprising an array of photovoltaic cells having a positive DC output terminal and a negative DC output terminal; connecting the positive DC transmission line to the positive DC output terminal; and connecting the negative DC transmission line to the negative DC output terminal.

It is noted that where the storage heating tank comprises a prior fitted heating unit, the method may further include: providing a retrofittable heating unit comprising the AC heating unit and the DC heating unit; removing the prior fitted heating unit; and retrofitting the retrofittable heating unit to the storage heating tank. Variously, the retrofittable heating unit may be fitted by screwing the retrofittable heating unit into the storage heating tank, by bolting the retrofittable heating unit to the storage heating tank. on agreement of the claims or the like.

According to still other embodiments, a water heating system is disclosed comprising a tank, and a retrofittable heating unit, comprising: an AC connector for connecting to a mains power source; a DC connector for connecting to a DC power source; an AC heating element; a DC heating element; a AC thermostat; a DC thermostat; and a base plate comprising: a first dock for supporting the AC heating element; a second dock for supporting the DC heating element; a third dock for supporting the DC thermostat; a fourth dock for supporting the AC thermostat; and a set of radially elongated bolt-holes. Optionally, the set of radially elongated bolt-holes comprises a set of six bolt holes situated at sixty degree intervals at a fixed around the base plate such that their center points form the vertices of an equilateral hexagon.

Optionally, the first dock comprises: a first aperture through the base plate; and a first pair of coupling bolts extending from an underside of the base plate; and the AC heating element comprises: an extended heating portion; and a sealing rim. The first aperture may be configured to receive the AC heating element such that the extended heating portion extends therethrough until the sealing rim meets the underside of the base plate; and the coupling bolts may be configured to engage with corresponding bolt-holes in the sealing rim such that the sealing rim forms a water-tight connection with the base plate. Optionally, again, the second dock comprises: a second aperture through the base plate; and a second pair of coupling bolts extending from an underside of the base plate; and the DC heating element comprises: an extended heating portion; and a sealing-rim. The second aperture is configured to receive the DC heating element such that the extended heating portion extends therethrough until the sealing-rim meets the underside of the base plate;

and the coupling bolts are configured to engage with corresponding bolt-holes in the sealing rim such that the sealing rim forms a water-tight connection with the base plate. Optionally, the third dock may comprise a third aperture through the base plate having an internal thread configured to couple with an external thread of the DC thermostat. Similarly the fourth dock may comprise a fourth aperture through the base plate having an internal thread configured to couple with an external thread of the AC thermostat.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a block diagram schematically representing an embodiment of a storage heating system including both an AC heating unit and a DC heating unit operable to heat water installed in a common tank;

FIG. 2A is a schematic diagram representing selected features of a first embodiment of the solar heating system of the current invention;

FIG. 2B is a schematic diagram representing selected features of a second embodiment of the solar heating system of the current invention;

FIG. 2C is a schematic diagram representing selected features of a third embodiment of the solar heating system of the current invention;

FIG. 3A is an isometric projection representing a first embodiment of a retrofittable heating unit for retrofitting AC and DC heating elements to a standard water heater tank thereby converting a standard AC powered water heater tank into a solar heating tank of the current invention;

FIGS. 3B-D show an isometric projection, a top view and a cross section of a possible terminal block for use with the first embodiment of a retrofittable heating unit;

FIGS. 4A and 4B show exemplary dimensions of the terminal block of the first embodiment of a retrofittable heating unit;

FIG. 5A and FIG. 5B are an isometric projection and a bottom view representing a second embodiment of a retrofittable heating unit for retrofitting AC and DC heating elements to another standard AC powered water heater tank;

FIG. 5C is a plane view of a possible base plate for use with the second embodiment of the retrofittable heating unit;

FIGS. 6A-D are a series of figures representing possible stages in the assembly of the second embodiment of the retrofittable heating unit of FIG. 5A;

FIGS. 7A and 7B show two sets of exemplary dimensions of the base plate of the first embodiment of a retrofittable heating unit;

FIG. 8 is a schematic representation of a possible implementation of the solar heating system for use in a multiple unit building sharing a common array of solar panels; and

FIG. 9 is a flowchart showing the steps of a method for providing a solar heating system of the current invention.

### DETAILED DESCRIPTION

In various embodiments of the invention, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data. Optionally, a network connection may additionally or alternatively be provided. User interface devices may be provided such as visual displays, audio output devices, tactile outputs and the like. Furthermore, as required user input devices may be provided such as keyboards, cameras, microphones, accelerometers, motion detectors or pointing devices such as mice, roller balls, touch pads, touch sensitive screens or the like.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

It is noted that the systems and methods of the invention herein may not be limited in their application to the details of construction and the arrangement of the components or methods set forth in the description or illustrated in the drawings and examples. The systems and methods of the invention may be capable of other embodiments or of being practiced or carried out in various ways.

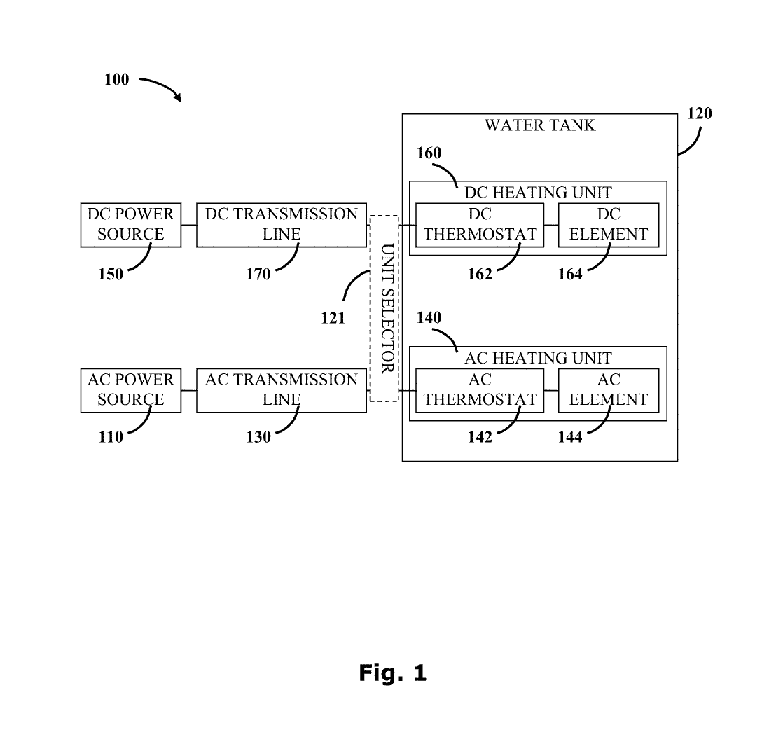

Reference is now made to the block diagram of FIG. 1 which schematically represents an embodiment of a storage heating system 100 including both an alternating current (AC) heating unit 140 and a direct current (DC) heating unit 160.

It is a particular feature of the storage heating system 100 that both the AC heating unit 140 and the DC heating unit are operable to heat water installed a single water tank 120.

Furthermore it is particularly noted that the storage heating system 100 draws power from at least two sources of electricity, an AC power source 110, such as an electrical grid and also a DC power source 150 such as a solar panel having an array of photovoltaic (PV) cells. The AC heating unit 140 is connected to the AC power source 110 via an AC transmission line 130 such as a mains line. The DC heating element 160 is connected to the DC power source 150 via a DC transmission 170.

The AC heating unit 140 includes at least one AC heating element 144 and an AC thermostat 142. The AC thermostat 142 is operable to deactivate said AC heating element 142 when water contained within the storage heater exceeds a threshold temperature thereby preventing overheating of the system when heated by the AC element. Typically the threshold temperature may be set manually as required.

It is noted that where appropriate, the AC heating unit 140 may include multiple AC heating elements (not shown). For example an upper AC heating element may be provided for use during periods of heavy water usage and a lower AC heating element may be provided for use as a recovery heater. Accordingly each AC heating element may have its own thermostat.

The DC heating unit 160 includes at least one DC heating element 164 and a DC thermostat 162. The DC thermostat 162 is operable to deactivate said DC heating element 162 when water contained within the storage heater exceeds a threshold temperature thereby preventing overheating of the system when heated by the DC element. The threshold temperature setting of the DC thermostat may be equal to the threshold temperature setting of the AC thermostat or alternatively the AC thermostat and the DC thermostat may have different threshold temperature settings.

It is particularly noted that because DC switches may be prone to arcing, the DC thermostat may be characterized by the inclusion of arc protection components such as arc suppressing capacitors or the like.

It is further noted that, by way of example, the DC heating element 162 may include an outer sheath, a heating coil, an unheated zone including a first cold pin connecting the heating coil to a positive DC connector and a second cold pin connecting the heating coil to a negative DC connector, and an insulating filler disposed between the outer-sheath and the heating coil. The heating coil may be selected to have a resistance of between 5 to 15 ohms when a voltage of 40-120 volts is applied between said positive DC connector and said negative DC connector.

Optionally the maximum power output of the DC heating element may range from 200 watts to 120 watts, with a possible optimum operation voltage of about 75 volts, a possible optimum operation current between 6 amps to 16 amps, an open circuit voltage of about 90 volts, a short circuit current between 6 amps to 16 amps.

Where required, optionally, the storage heating system 100 may further include a unit selector 121 operable to select either the AC heating unit, the DC heating unit or both as suit requirements. Factors effecting the selection of the appropriate heating unit may include availability of DC power, which may depend upon availability of solar energy, for example, or power level of an electrochemical cell or the like. Thus the DC heating element may be preferred during the day when solar energy is available.

Furthermore, where required, the AC heating element may be operable to respond to an intelligent electrical power distribution system. Thus, for example, the AC heating element may be activated remotely by the AC power supplier via loadshedding requests.

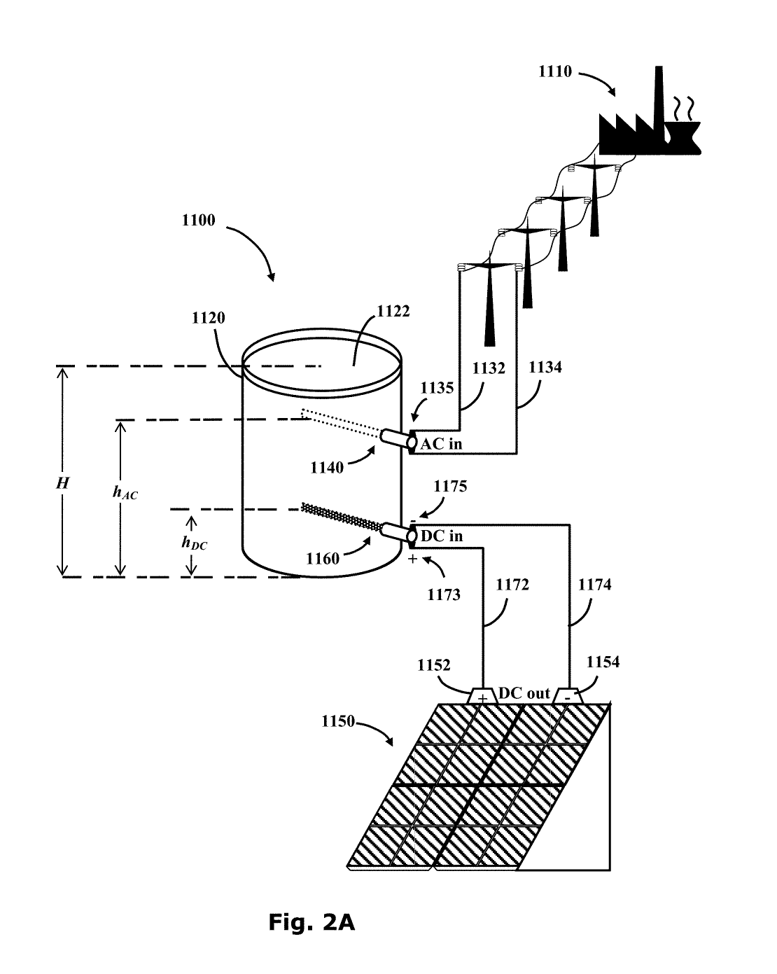

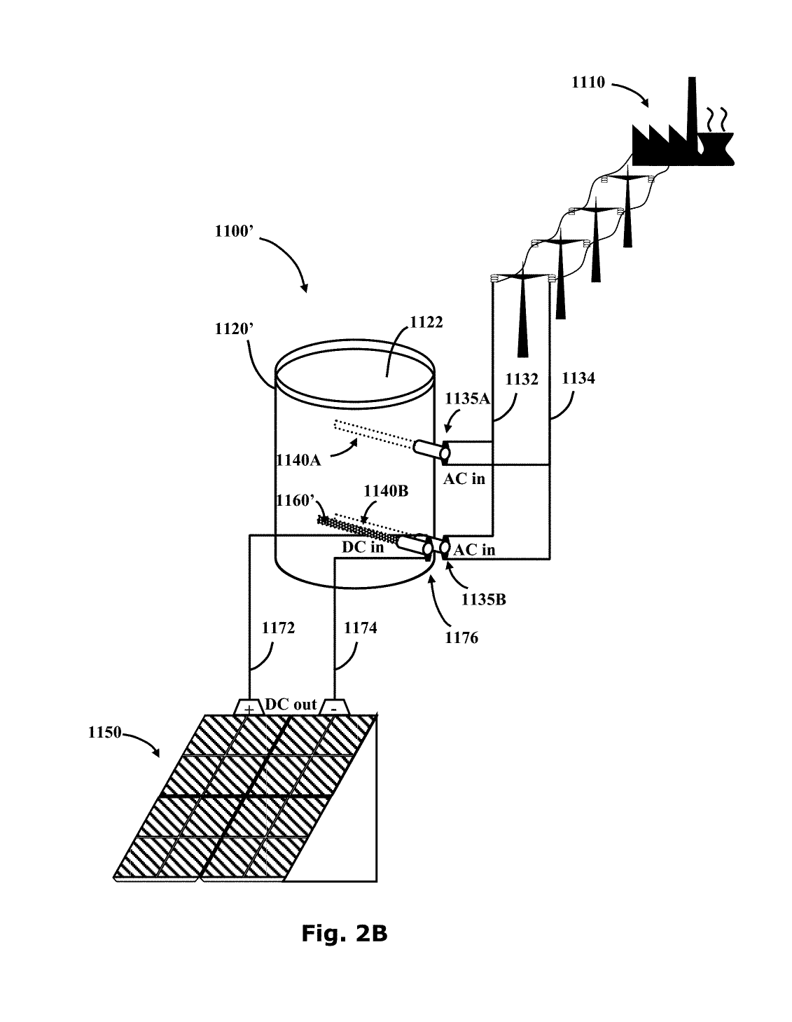

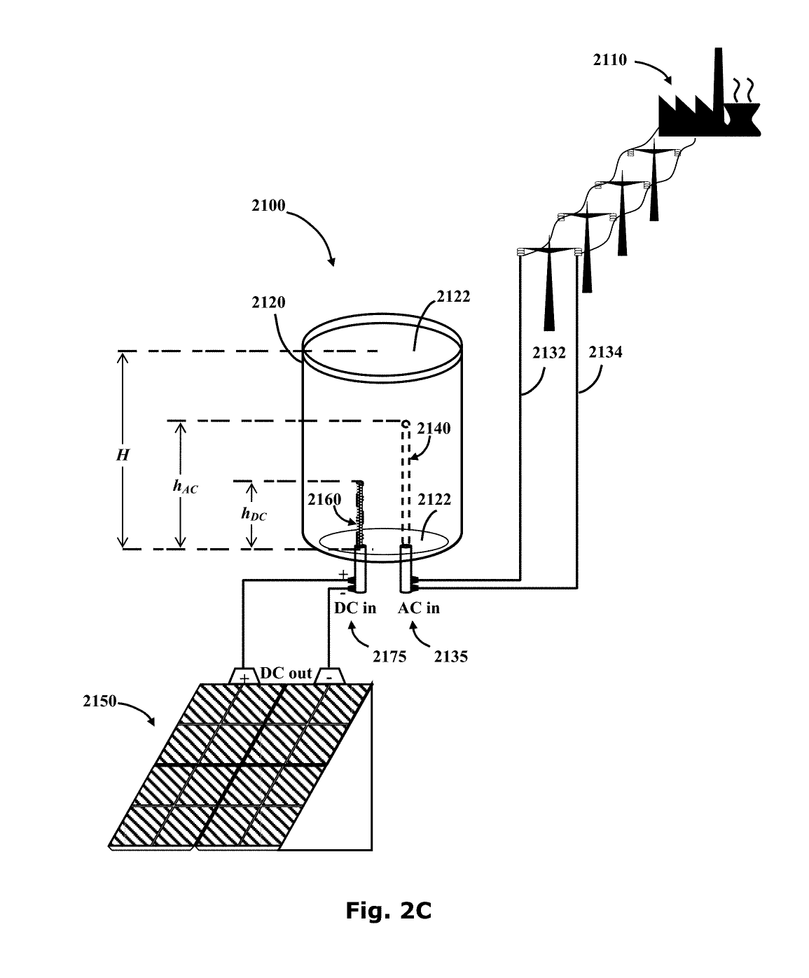

Reference is now made to FIG. 2A schematically representing selected elements of a first example of the solar heating system 1100. The solar heating system 1100 includes a storage tank 1120, an AC heating element 1140 and a DC heating element 1160.

The storage heater 1120 is filled with water 1122 to a fill-height H. The water may be heated by either the AC heating unit 1140, the DC heating unit 1160 or both as required. The AC heating unit 1140 is immersed into the water reservoir 1122 at a maximum element-height of h_{AC} where h_{AC} is less than or equal to two-thirds of the fill-height H. Similarly, the DC heating unit 1160 is immersed into the water reservoir 1122 at a maximum element-height of h_{DC} where h_{DC} is less than or equal to two-thirds of the fill-height H. It is noted that the AC heating unit may include an AC heating element and an AC thermostat, and the DC heating unit may include an DC heating element and an DC thermostat as described above in reference to FIG. 1.

It is further noted that storage tank 1120 of the solar heating system 1100 disclosed herein is particularly characterized by only requiring a single water inlet for fresh water and a single outlet for providing hot water on demand. It is a particular advantage of the solar heating system 1100 of the embodiment that unlike the four access pipes required by solar heaters of the prior art, the storage tank 1120 requires only two access pipes are required.

In the first example, the AC heating unit 1140 is installed as an upper heating element and the DC heating unit 1160 is installed as a lower heating element. Accordingly, the AC heating unit 1140 may be used to provide additional heating of the water 1122 at times of high water usage and the DC heating unit 1160 may be used as a recovery heater to provide a background heating as solar power is available.

It will be appreciated that the positions of the DC heating unit 1160 and the AC heating unit 1140 of the invention may be different that the positions indicated herein, for example the DC heating element may be situated higher than the AC heating element or at the same height as required.

The DC power supply of the first example is a solar panel 1150 including an array of photovoltaic cells wired to a positive DC output terminal 1152 and a negative DC output terminal 1154. The positive DC output terminal 1152 is wired to a DC positive transmission line 1172, which is wired to a positive DC input terminal 1173 of the DC heating unit 1160. Similarly, the negative DC output terminal 1154 is wired to a DC negative transmission line 1174, which is wired to a negative DC input terminal 1175 of the DC heating unit 1160.

The AC power supply of the first example is a mains connection to a power grid drawing power from a power station 1110. The mains connection typically has a live transmission line 1132 and a neutral transmission line 1134 leading to a pair of AC input terminals 1135.

It is also noted that although a vertically storage tank is indicated in the figures, the solar heating system may be equally integrated into a horizontally orientated storage heating tank.

Referring now to FIG. 2B, a second example of the solar heating system 1100′ is represented. The second example of the solar heating system 1100′ includes a storage heater 1120′ having a dual element AC heating unit including an upper AC heating element 1140A and a lower AC heating element 1140B. Both the upper AC heating element 1140A and the lower AC heating element 1140B are connected to the mains transmission lines 1132, 1134 via separate AC input terminals 1135A, 1135B.

In addition to the AC heating unit 1140A, 1140B the second example of the solar heating system 1100′ further includes a DC heating unit 1160′ which is installed alongside the lower AC heating unit 1140B and is connected to the solar panel via the positive DC transmission line 1172 and the negative DC transmission line 1174 which are wired to a pair of DC input terminals 1176.

It is noted that the DC heating unit 1160 and the lower AC heating unit 1140 may be mounted to a common retrofittable terminal block as described hereinbelow.

With reference to FIG. 2C selected features of a third example of the solar heating system 2100 are represented. The third example of the solar heating system 2100 includes a storage heater 2120′, an AC heating element 2140 and a DC heating element 2160.

In the second example, the AC heating unit 2140 and the DC heating unit 2160 are both mounted to a common base plate 2124. It is noted that the bottom mounted AC heating unit may include an AC heating element and an AC thermostat, and the bottom mounted DC heating unit may include an DC heating element and an DC thermostat as described above in reference to FIG. 1. Accordingly the base plate may include an AC heating element dock for accommodating the AC heating element, an AC thermostat dock for accommodating the AC thermostat, a DC heating element dock for accommodating the DC heating element, and a DC thermostat dock for accommodating the DC thermostat. An example of a retrofittable base plate is described hereinbelow.

The bottom mounted AC heating unit is connected to an AC power source 2110 via mains transmission lines 2132, 2134 wired to a pair of AC input terminals 2135. Similarly the bottom mounted DC heating unit is connected to a DC power source such as a solar panel 2150 via pair of DC input terminals.

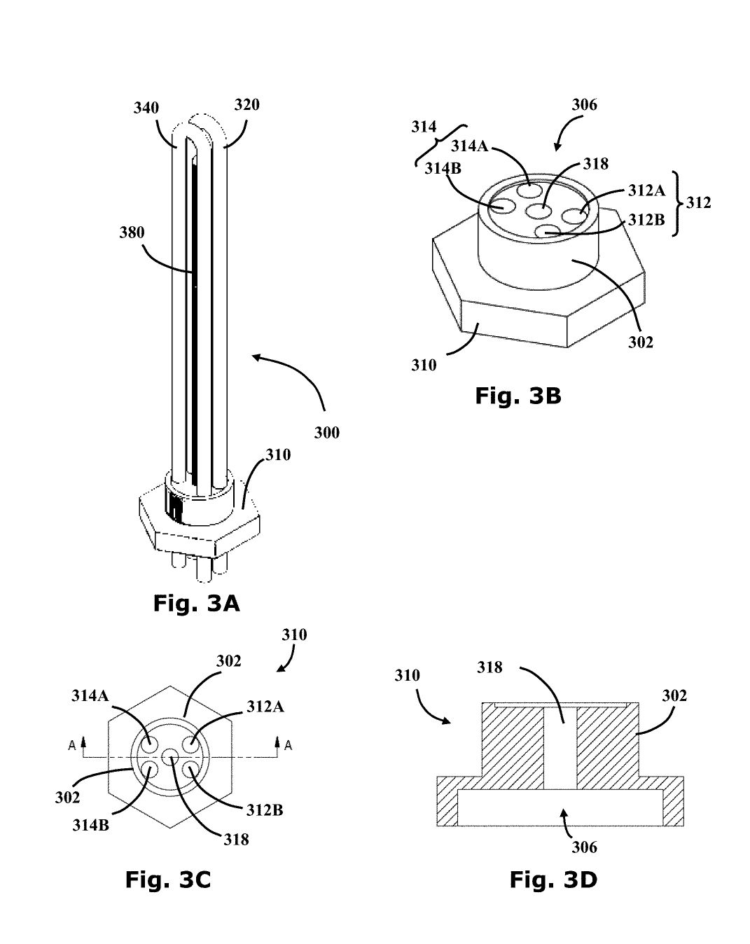

Referring now to FIG. 3A, various projections are shown representing a first example of a retrofittable heating unit 300. The retrofittable heating unit 300 may be used for converting a standard AC powered water heater tank into a solar heating tank of the current invention.

The retrofittable heating unit 300 includes a terminal block 310, an AC heating element 320, a DC heating element 340, and a DC thermostat 380. It is noted that such a retrofittable heating unit 300 may be configured with dimensions suitable for replacing a standard AC heating element of a standard AC powered water storage heater. Accordingly the terminal block 310 may include a screw-in flange connector ring having an external thread configured to engage an internal thread through a wall of the storage tank.

Referring now to FIGS. 3B-D schematic representations are shown of a possible screw-in type terminal block 310 for retrofitting AC and DC heating elements to a standard water heater tank. FIG. 3B shows an isometric projection of the screw-in type terminal block 310, FIG. 3B shows a top view of the screw-in type terminal block and FIG. 3D shows a cross section of the screw-in type along the line A-A shown in FIG. 3C.

The screw-in type terminal block includes a screw-in flange connector ring 302 encompassing a central channel 306, an AC heating element dock 312 for supporting the AC heating element 320, a DC heating element dock 314 for supporting the DC heating element 340, and a DC thermostat dock 318 for supporting the DC thermostat 380. It is noted that typically, standard AC storage heater tanks have separate AC thermostats mounted independently of the AC heating element. Accordingly, when retrofitting the terminal block 300 to a standard AC storage heating tank, the AC heating element may be wired directly to the original AC thermostat. Nevertheless, it is particularly noted that, where required, the terminal block 300 may further include an AC thermostat dock (not shown) provided to support an AC thermostat.

The AC heating element 320 of the example is a loop type heating element and the corresponding AC heating element dock 312 of the example has two apertures 312A, 312B to accommodate the two ends of the heating element. Similarly the DC heating element 340 of the example is a loop type heating element and the corresponding DC heating element dock 314 of the example has two apertures 314A, 314B to accommodate the two ends of the heating element. The organization of the AC heating element dock 312, the DC heating element dock 314 and the DC thermostat dock 318 has dimensions suitable such that the AC heating element 320, the DC heating element 340 and the DC thermostat 380 all fit within the circumference of the central channel 306. It is noted that where required an AC thermostat may also be incorporated into the central channel as required.

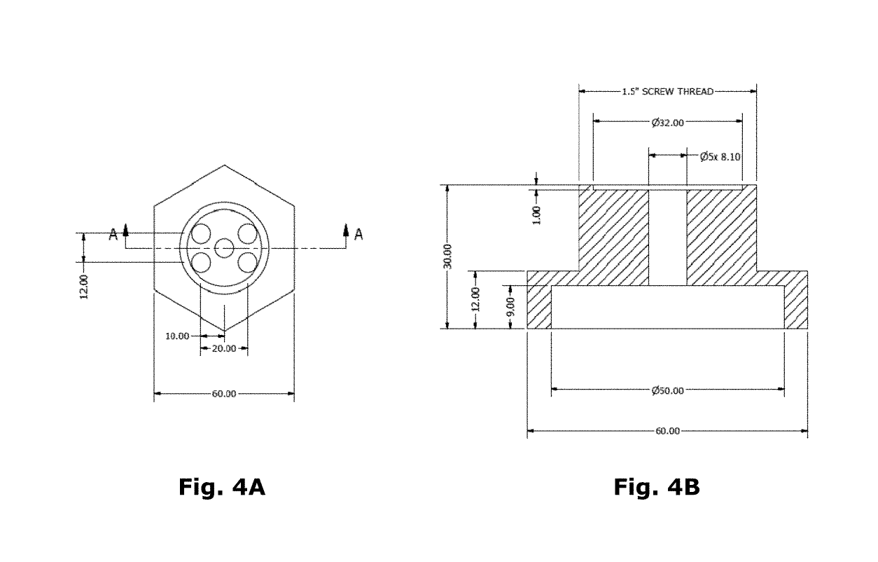

For illustrative purposes a screw-in type terminal block 300 is represented in FIGS. 3A-D, which has an externally threaded connector ring 302 and is configured to screw into a corresponding internally threaded aperture of a storage tank. Accordingly it may have standard dimensions suitable for integration into standard AC storage heaters. By way of example, FIGS. 4A and 4B show exemplary dimensions for the terminal block of the retrofittable heating unit.

Although, for illustrative purposes only a screw-in type terminal block 300 is represented in FIGS. 3A-D and FIGS. 4A-B, it will be appreciated that other types of terminal blocks may be provided. For example an alternative terminal block may include a flanged connector configured to be bolted to a wall of said tank thereby providing access therethrough for the AC heating element, the DC heating element and the DC thermostat. Such a flanged connector may be used to retrofit the terminal block to a standard water storage heater whose AC element is bolted to the tank.

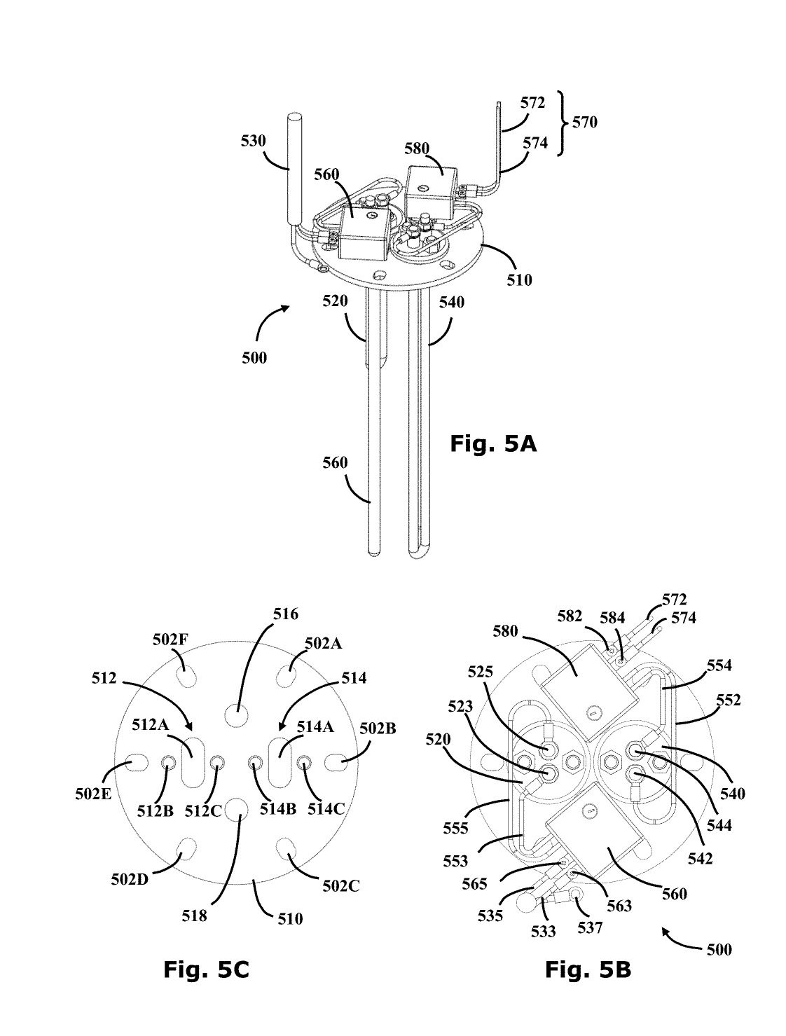

Reference is now made to FIG. 5A representing an isometric projection of the second example of a retrofittable heating unit 500 for use converting another type of standard AC powered water heater tank such that it may be incorporated into a solar heating system as described herein.

The second example of the retrofittable heating unit 500 includes a base plate 510, an AC heating element 520, a DC heating element 540, an AC thermostat 560, a DC thermostat 580, an AC connector 530, and a DC connector 570.

Referring now to FIG. 5B representing a bottom view of the second example of a retrofittable heating unit 500, the AC connector 530 may be wired to the AC heating element 520 via the AC thermostat 560, and the DC connector 570 may be wired to the DC heating element 540 via the DC thermostat 580.

The AC connector 530 may be a three core mains wire including a live wire 533, a neutral wire 535 and an earth wire 537. The live wire 533 may be connected to a first input terminal 563 of the AC thermostat 560. The neutral wire 535 may be connected to a second input terminal 565 of the AC thermostat 560. The earth wire 537 may be connected to a metal casing of the storage tank to prevent the conducting casing from becoming live.

The AC thermostat 560 may be connected to the AC heating element 520 via live and neutral AC bridging wires 553, 555 wired to the live input terminal 523 and the neutral input terminal 535 of the AC heating element 520.

The DC connector 570 may include a positive lead 572 and a negative lead 574. The positive lead 572 may be connected to a positive input terminal 582 of the DC thermostat 580. The negative lead 574 may be connected to the negative input terminal 584 of the DC thermostat 580.

The DC thermostat 580 may be connected to the DC heating element 550 via positive and negative bridging wires 552, 554 wired to the positive input terminal 542 and the negative input terminal 544 of the DC heating element 540.

The retrofittable base plate 510 may be used to replace a standard base plate of a standard AC powered water heater. Typically such a standard base plate may provide only a single AC heating element and an AC thermostat and would therefore be unsuitable for integration into a solar heating system such as described herein.

By contrast, referring now to FIG. 5C showing a plane view of a possible base plate, the retrofittable base plate 510 described herein has four docks: an AC heating element dock 512 for supporting the AC heating element 520, a DC heating element dock 514 for supporting the DC heating element 540, an AC thermostat dock 516 for supporting the AC thermostat 560 and a DC thermostat dock 518 for supporting the DC thermostat 580.

The retrofittable base plate 510 further includes fastening agents for attaching the base plate to the water tank in a sealable manner. The fastening agents of the example include a set of radially elongated bolt-holes 502A-F which are configured to couple with similarly spaced bolts (not shown) protruding from water tank. As shown in FIG. 5B, showing a possible configuration of the various apertures of the base plate 510, the fastening agents, may be situated at sixty degree intervals at a fixed around said base plate such that their center points form the vertices of an equilateral hexagon.

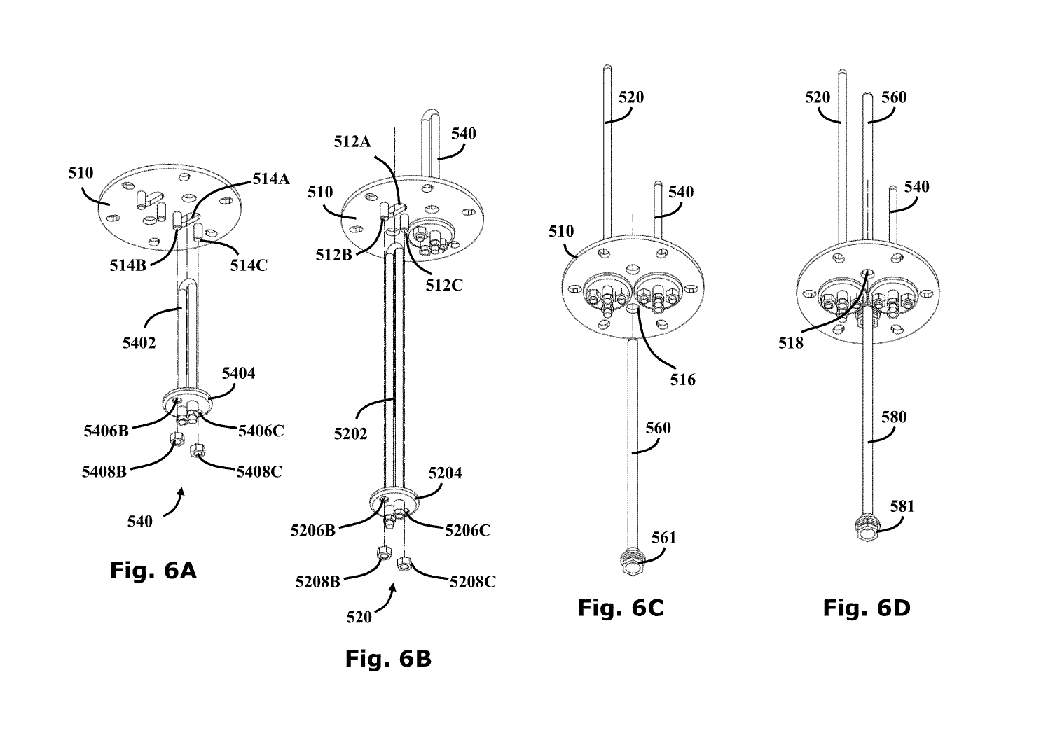

The AC heating element dock 512 includes an AC element aperture 512A and a first pair of coupling bolts 512B, 512C. The AC element aperture 512A provides an access hole through which the AC heating element 520 may be introduced into the heating tank. The first pair coupling bolts 512B, 512C extend from an underside of the base plate 510 and may be used to couple with the AC heating element 520. Accordingly, as shown in FIG. 6B, the AC heating element 520 may include an extended heating portion 5202 and a sealing rim 5204 having two engagement bolt-holes 5206B, 5206C which may be used to secure the AC heating element 520 to the base plate 510 using fastening nuts 5208B, 5208C, thereby forming a watertight connection. Optionally a sealing ring or a washer, of silicon or other suitable material (not shown) may be introduced between the sealing rim 5204 of the AC heating element 520 and the base plate 510 as required.

Similarly, the DC heating element dock 514 includes a DC element aperture 514A and a second pair of coupling bolts 514B, 514C. The DC element aperture 514A provides an access channel through which the DC heating element 520 may be introduced into the heating tank. The second pair of coupling bolts 514B, 514C extend from an underside of the base plate 510 and may be used to couple with the DC heating element 540. Accordingly, as shown in FIG. 6A, the DC heating element 540 may include an extended heating portion 5402 and a sealing rim 5404 having two engagement bolt-holes 5406B, 5406C which may be used to secure the DC heating element 540 to the base plate 510 using fastening nuts 5408B, 5408C, thereby forming a watertight connection. Optionally a sealing ring or a washer, of silicon or other suitable material (not shown) may be introduced between the sealing rim 5404 of the AC heating element 540 and the base plate 510 as required.

The AC thermostat dock 516 may include an aperture through the base plate providing an access-channel through with the AC thermostat 560 may be introduced into the tank. As required, the aperture 516 may have an internal thread configured to couple with an external thread 561 of a terminal coupling ring of the AC thermostat.

Similarly, the DC thermostat dock 518 may include an aperture through the base plate providing an access-channel through with the DC thermostat 580 may be introduced into the tank. As required, the aperture 518 may have an internal thread configured to couple with an external thread 581 of a terminal coupling ring of the DC thermostat.

FIGS. 6A-D show a series of representations of possible stages in the assembly of the second embodiment of the retrofittable heating unit of FIG. 5A. FIG. 6A shows the base plate 510 and the components of the DC heating element 540. The extended heating portion 5402 of the DC heating element 540 is introduced into the DC heating element aperture 514A and may be secured thereto using fastening nuts 5408B, 5408C.

FIG. 6B shows the base plate 510 with the DC heating element 540 attached thereto and the components of the AC heating element 540. The extended heating portion 5202 of the AC heating element 520 is introduced into the AC heating element aperture 512A and may be secured thereto using fastening nuts 5208B, 5208C.

FIG. 6C shows the base plate 510 with the DC heating element 540 and the AC heating element 520 attached thereto and the AC thermostat 560 being introduced into the AC thermostat dock 516.

FIG. 6D shows the base plate 510 with the DC heating element 540 and the AC heating element 520 and the AC thermostat 560 attached thereto and the DC thermostat 580 being introduced into the DC thermostat dock 518.

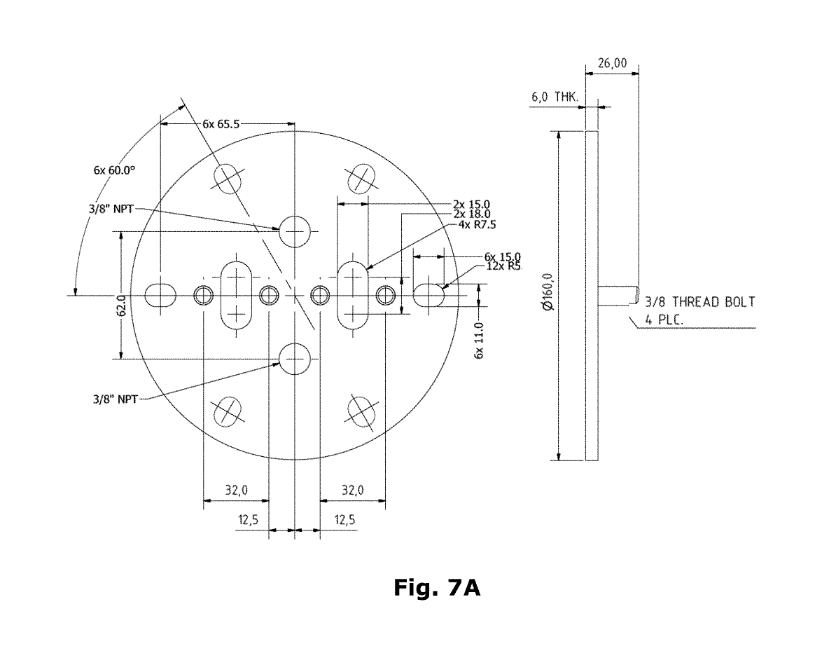

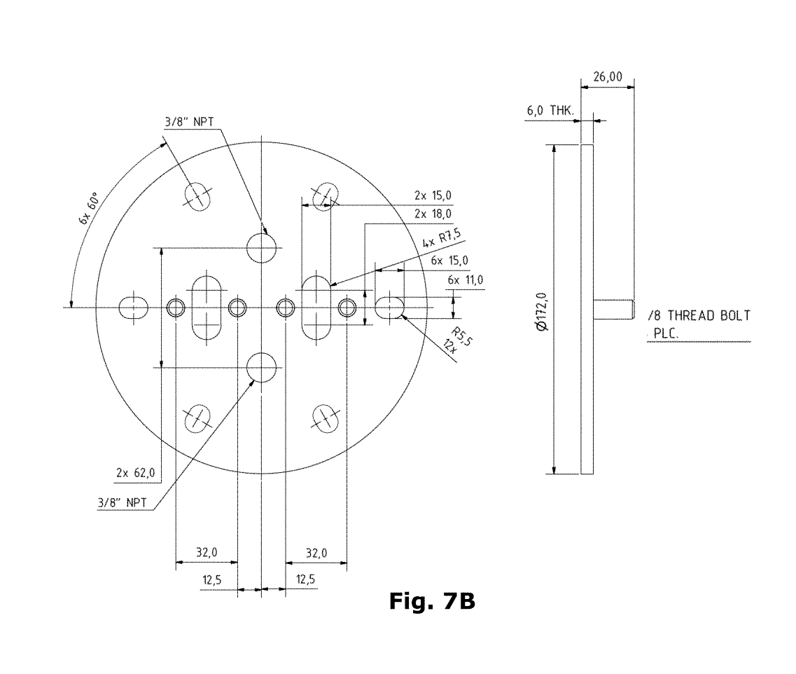

It will be appreciated that the base plate of the second embodiment may be retrofitted to standard AC storage heaters. Accordingly the base plate may have standard dimensions suitable for integration into standard AC storage heaters. By way of example, FIGS. 7A and 7B show two sets of exemplary dimensions for the terminal block of the retrofittable heating unit.

The base plate of FIG. 7A has a diameter of 160 millimeters, whereas the base plate of the FIG. 7B has a diameter of 172 millimeters.

Although, for illustrative purposes only a screw-in type terminal block 300 is represented in FIGS. 3A-D and FIGS. 4A-B, it will be appreciated that other types of terminal blocks may be provided. For example an alternative terminal block may include a flanged connector configured to be bolted to a wall of said tank thereby providing access therethrough for the AC heating element, the DC heating element and the DC thermostat. Such a flanged connector may be used to retrofit the terminal block to a standard water storage heater whose AC element is bolted to the tank.

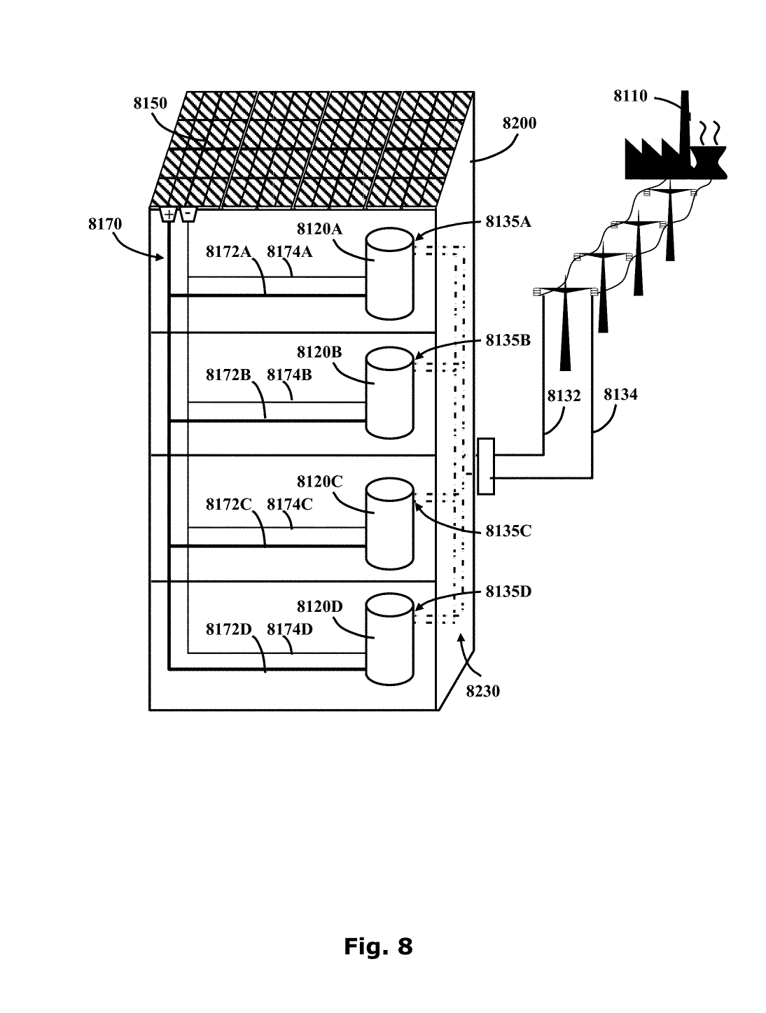

By way of further illustration of the principle of the solar heating system, reference is now made to FIG. 8 schematically representing a possible implementation of the solar heating system 8100 for use in a building 8200 having multiple storage heating tanks 8135A-D all drawing power from both an AC power source 8110 and a common array of roof mounted solar panels 8150.

The building 8200 includes a central AC mains line 8230 connected to the AC power source 8110 such as a power station, generator or the like, via live and neutral AC transmission lines 8132, 8134. Each storage heating tank 8120A-D is connected to the AC mains line 8230 via its own pair of AC input terminals 8135A-D.

Furthermore, the building has a set of roof mounted solar panels 8150 which are connected to a central DC power transmission line 8170 which may provide DC power to each storage heating tank 8120A-D via dedicated DC positive and negative transmission lines 8172A-D, 8174A-D.

It is noted that where appropriate, the roof mounted solar panels may replace roof mounted solar thermal heat collectors to provide a central DC electricity supply. Accordingly, solar energy may be collected and transferred to the storage heating tanks via electrical conduction transmission lines and DC heating elements rather than via complicated and damage prone fluid communication lines and heat exchangers.

Although only roof mounted solar panels are represented herein, it is noted that wall mounted or window mounted solar panels may be integrated into the system. It is further noted, photovoltaic cells do not require direct sunlight and where necessary may be mounted upon any of a south facing, north facing, east facing, west facing or any other directed wall of a building. Nevertheless, PV cells may be more effective if orientated towards the sun. Thus in the Northern Hemisphere, south facing solar panels are generally to be preferred and in the Southern Hemisphere, north facing solar panels are generally to be preferred. In other embodiments, solar tracking mountings may be used which are operable to orientate the solar panels towards the sun across an east to west path throughout the day or a north-south path according to the varying elevations of the sun throughout the year.

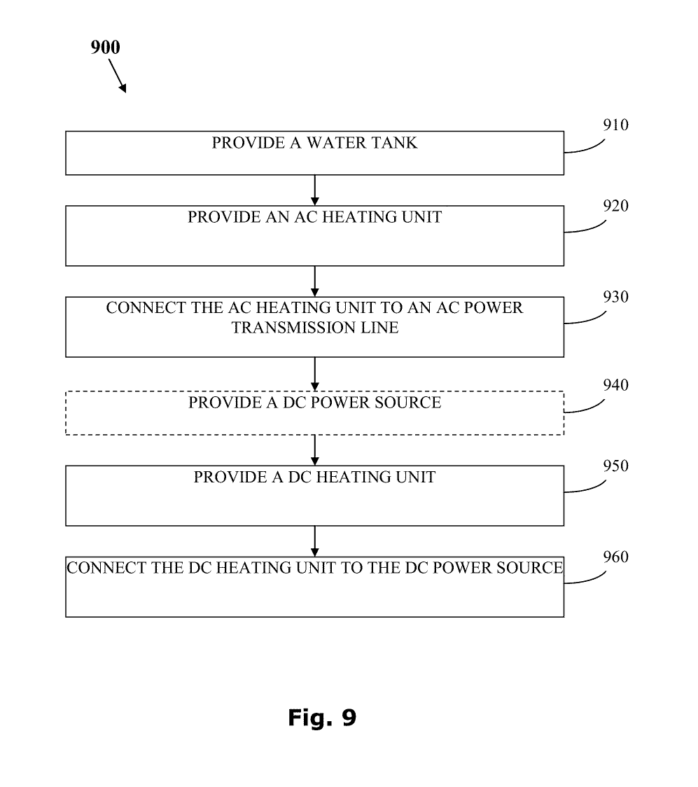

Referring to the flowchart of FIG. 9, selected steps are presented of a method 900 for providing a solar heating system of the current invention. A storage heating tank is provided 910, for example a water tank suitable for heating and storing water contained therein. An AC heating unit is provided 920, the AC heating unit generally including a heating element connected to a thermostat is operable to draw power from an AC source, such as a mains line and to heat water contained within the tank. The AC heating unit may be connected to the AC power transmission line 930. It is noted that, where a DC heating unit is to be retrofitted to an existing dual element AC storage heating tank, the AC heating unit provided may already be connected to the AC transmission line.

A DC heating unit is provided 950. Such a DC heating unit may be a retrofittable DC heating element connected to a DC thermostat. Accordingly, the step of providing the DC heating unit may further include removing an existing AC heating unit and replacing it with at least a DC heating unit. As described hereinabove, in various embodiments, an existing AC heating unit may be replaced by both a DC heating unit and a new AC heating unit, as required.

Accordingly, where the storage heating tank comprises a prior fitted heating unit, the method may further include: providing a retrofittable heating unit comprising the AC heating unit and the DC heating unit; removing the prior fitted heating unit; and retrofitting the retrofittable heating unit to the storage heating tank. Variously, the retrofittable heating unit may be fitted by screwing the retrofittable heating unit into the storage heating tank, by bolting the retrofittable heating unit to the storage heating tank on agreement of the claims or the like.

The DC heating unit is connected to a DC power source 960, such as a solar panel or the like. Where no DC power source is available, a DC power source may be provided 940. For example a solar panel may be set up such that an array of photovoltaic cells collect solar power converting it into DC electric output.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number, and a second indicate number and “ranging/ranges from” a first indicate number “to” a second indicate number are used herein interchangeably and are meant to include the first and second indicated numbers and all the fractional and integral numerals there between. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

What is claimed is:

1. A water heating system comprising a water tank, and an AC heating unit, said AC heating unit comprising an AC heating element, an AC thermostat operable to deactivate said AC heating element when water contained within said water tank exceeds a first threshold temperature, a live input terminal configured to connect to a live mains transmission line; and a neutral input terminal configured to connect to a neutral mains transmission line;
wherein said water heating system further comprises a DC heating unit, said DC heating unit comprising:
a DC heating element, a DC thermostat operable to deactivate said DC heating element when water contained within said water tank exceeds a second threshold temperature;
a positive input terminal configured to connect to a positive DC power transmission line; and
a negative input terminal connected to a negative DC power transmission line.

2. The water heating system of claim 1 wherein said first threshold temperature equals said second threshold temperature.

3. The water heating system of claim 1 wherein said DC power source comprises an array of photovoltaic cells.

4. The water heating system of claim 1 wherein said DC heating element is configured to be immersed into said tank at an element-height h_{DC} and said tank is configured to contain water up to a fill-height H wherein the element-height h_{DC} is less than or equal to two-thirds of the fill-height H.

5. The water heating system of claim 1 wherein said AC heating element is configured to be immersed into said tank at an element-height h_{AC} and said tank is configured to contain water up to a fill-height H wherein the element-height h_{AC} is less than or equal to two-thirds of the fill-height H.

6. The water heating system of claim 1 wherein said AC heating element is connected to said AC connector via said AC thermostat and said AC thermostat is operable to deactivate said AC heating element when water contained within said tank exceeds a threshold temperature.

7. The water heating system of claim 1 wherein said DC heating element is connected to said DC connector via said DC thermostat and said DC thermostat is operable to deactivate said DC heating element when water contained within said tank exceeds a threshold temperature.

8. The water heating system of claim 1 wherein said DC heating element comprises an outer sheath, a heating coil, a first cold pin connecting said heating coil to a positive DC connector and a second cold pin connecting said heating coil to a negative DC connector, and an insulating filler disposed between said outer-sheath and said heating coil and wherein said heating coil is selected to have a resistance of between 5 to 15 ohms when a voltage of 120 volts is applied between said positive DC connector and said negative DC connector.

9. The water heating system of claim 1 wherein said DC thermostat comprises DC switches having arc protection components.

10. The water heating system of claim 9 wherein said arc protection components comprise DC switch arc suppressing capacitors.

11. The water heating system of claim 1, further comprising a solar panel comprising an array of photovoltaic cells, a positive output terminal and a negative output terminal; said positive DC power transmission line is connected to said positive output terminal; and said negative DC power transmission line is connected to said negative output terminal.

12. A water heating system comprising a tank, and a retrofittable heating unit,
said retrofittable heating unit comprising:
an AC connector for connecting to a mains power source;
a DC connector for connecting to a DC power source;
an AC heating element;
a DC heating element;
a DC thermostat; and
a terminal block configured to fasten to a wall of said tank and to provide access therethrough for said AC heating element, said DC heating element and said DC thermostat, said terminal block comprising:
a first dock for supporting the AC heating element;
a second dock for supporting the DC heating element; and
a third dock for supporting the DC thermostat.

13. The water heating system of claim 12 wherein said terminal block comprises a screw-in flange connector ring having an external thread configured to engage an internal thread through said wall of said tank, said connector ring encompassing a central channel and said first dock, said second dock and said third dock provide access through said central channel.

14. The water heating system of claim 12 wherein said terminal block comprises a flanged connector configured to be bolted to said wall.

15. A method for providing a solar heating system, said method comprising:
providing a storage heating tank;
providing an AC heating unit comprising an AC heating element, an AC thermostat operable to deactivate said AC heating element when water contained within said storage heating tank exceeds a first threshold temperature, a live input terminal and a neutral input terminal;
providing a DC heating unit comprising a DC heating element, a DC thermostat operable to deactivate said DC heating element when water contained within said storage heating tank exceeds a second threshold temperature; a positive input terminal and a negative input terminal;
connecting said live input terminal and said neutral input terminal to a mains power transmission line;
connecting said positive input terminal to a positive DC transmission line; and
connecting said negative input terminal to a negative DC transmission line.

16. The method of claim 15 further comprising providing a DC power source.

17. The method of claim 15 further comprising:
providing a solar panel comprising an array of photovoltaic cells having a positive DC output terminal and a negative DC output terminal;
connecting said positive DC transmission line to said positive DC output terminal; and
connecting said negative DC transmission line to said negative DC output terminal.

18. The method of claim 15 wherein said storage heating tank comprises a prior fitted heating unit, said method comprising:
providing a retrofittable heating unit comprising said AC heating unit and said DC heating unit;
removing said prior fitted heating unit; and
retrofitting said retrofittable heating unit to said storage heating tank.

19. The method of claim 18 wherein the step of retrofitting said retrofittable heating unit to said storage heating tank comprises screwing said retrofittable heating unit into said storage heating tank.

20. The method of claim 18 wherein the step of retrofitting said retrofittable heating unit to said storage heating tank comprises bolting said retrofittable heating unit to said storage heating tank.
